(19) United States
(12) Patent Application Publication
(10) Pub. No.: US 2015/0176629 A1
(43) Pub. Date: Jun. 25, 2015

(54) NUT MEMBER

(71) Applicant: KOITO MANUFACTURING CO., LTD., Tokyo (JP)

(72) Inventor: Takeyuki Tachiiwa, Shizuoka-shi (JP)

(73) Assignee: KOITO MANUFACTURING CO., LTD., Tokyo (JP)

(21) Appl. No.: 14/416,305

(22) PCT Filed: Jul. 16, 2013
(86) PCT No.: PCT/JP2013/069255

§ 371 Date: Jan. 22, 2015

(30) Foreign Application Priority Data
Aug. 1, 2012 (JP) 2012-170698

(51) Int. Cl. F16B 37/04

(52) U.S. Cl. CPC F16B 37/04

(57) ABSTRACT

A nut member, which is used for an aiming mechanism of a lamp configured by an aiming screw 120 that is supported in a lamp body 101 so as to turn on its own axis and a nut member 1 that is supported in a bracket 109 of a reflector, includes a fitting portion 3 which is to be fitted in a fitting hole 110 provided in the bracket 109, and an internal thread portion 2 which is to be screwed on to an external thread portion 121 of the aiming screw 120, and an introducing portion 4 which guides the aiming screw 120, wherein the fitting portion 3 and the internal thread portion 2 are formed in different axial positions on the nut member 1.

### TECHNICAL FIELD

The present invention relates to a nut member that is suitable for use in an mechanism for adjusting the direction of an optical axis of a lamp.

### BACKGROUND ART

A lamp such as a motor vehicle headlamp includes an aiming mechanism for adjusting the direction of an optical axis of the lamp that constitutes the base for light irradiation directions. An aiming screw and an aiming nut are provided as main constituent members of the aiming mechanism.

FIG. 6 shows a conceptual configuration of an aiming mechanism. As shown in FIG. 6, a reflector 104 on which a light source (a bulb or an LED) 103 is supported is supported so as to tilt vertically and horizontally in a lamp housing 100 that is made up of a lamp body 101 and a front cover 102. An aiming adjustment is executed by adjusting vertical and horizontal tilting angles of the reflector 104. With a view to realizing the tilting operations of the reflector 104 configured as described above, a fulcrum portion 105 having a spherical joint construction is provided at one location on the back of the reflector 104, and an aiming portion 106 that executes vertical and horizontal adjustments is provided at a different location from the location where the fulcrum portion 105 is provided. Here, the vertical aiming portion 106 is shown. In this aiming portion 106, an aiming screw 120 is held on a lamp body 101 so as to turn on its own axis, and an aiming nut 107 that is supported in a bracket 109 of the reflector 104 is screwed on an external thread portion 121 of the aiming screw 120. The aiming nut 107 is screwed to move backwards or forwards by turning the aiming screw 120, and the reflector 104 tilts vertically and horizontally on the fulcrum portion 105 as a fulcrum as the aiming nut 107 is screwed to so move.

There may be a situation in which a nut member named as a so-called self-locking nut is used as this aiming nut 107. For example, in Patent Document 1, a self-locking nut has a pair of leg portions that are elastic in a radial direction, and these leg portions are fitted in a fitting hole 110 that is opened in the bracket 109 of the reflector 104 as shown in FIG. 6, whereby the self-locking nut or the aiming nut 107 is supported in the bracket 109. Additionally, an inner circumferential surface of an axial hole in the self-locking nut is configured as an internal thread portion, and the self-locking nut is screwed on to the external thread portion 121 of the aiming screw 120 at the internal thread portion. This internal thread portion is configured as a circumferential surface before the aiming screw is screwed thereinto. Then, by pressing fit the aiming screw into the axial hole while turning it, the inner circumferential surface of the axial hole is cut by the external thread portion so that the internal thread is formed.

### CITATION LIST

### Patent Document

Patent Document 1: JP-A-9-14244

### SUMMARY OF INVENTION

### Technical Problem

The self-locking nut (hereinafter, referred to simply as a nut member) of Patent Document 1 is configured so that the internal thread portion and a fitting portion are superposed one on the other in an axial direction of the nut member. Namely, the fitting portion is provided in an outer circumferential position of the internal thread portion. Because of this, when the aiming screw (hereinafter, referred to simply as the screw) is screwed into the nut member for press fitting insertion, the inner circumferential surface of the axial hole of the internal thread portion is expanded radially outwards by the screw, and this radially outward expansion increases the outside diameter of the fitting portion so that the dimensional margin that is set between the fitting hole in the bracket and the nut member is decreased. Therefore, when the nut member is moved in a straight line, in the axial direction with turning of the screw and then the reflector is tilted with the fulcrum portion as a center, this decrease, in turn, the margin for relative movement that is required between the fitting portion and the fitting hole. The smoothness between the nut member and the bracket is lost due to this, whereby the operation force in turning the screw is increased, and it is difficult for the nut member to be screwed to move along the external thread of the screw smoothly. As a result, the operability of the screw in aiming adjustment is reduced.

In addition, in the nut member of Patent Document 1, for the purpose of ensuring the required mechanical strength at the nut member, the radial thickness between the internal thread portion and the fitting portion lying on the outer circumference of the internal thread portion is designed to the required dimension or larger. Because of this, when the nut member is fabricated through resin molding, “sinking” is easy to be produced in the inner circumferential surface of the internal thread portion or the outer circumferential surface of the fitting portion. This “sinking” reduces the dimensional accuracy at the internal thread portion or the fitting portion, and this reduction in dimensional accuracy affects the operability of the screw in aiming adjustment when the screw is screwed into the nut member.

Further, in the nut member of Patent Document 1, the axial hole is only opened simply for formation of the internal thread portion on the side where the screw is inserted. Therefore, the work of inserting the distal end of the screw in the axial hole in the nut member becomes difficult. In particular, in assembling reflectors into lamp housings, on many occasions, the reflectors are not oriented in the predetermined direction highly accurately in posture. This makes it difficult for the screw to be inserted into the nut member by aligning the direction of the axial hole in the nut member with the axial center direction of the screw on the same straight line, deteriorating the workability in assembling the aiming mechanism.

An object of the invention is to provide a nut member that can improve the operability in aiming adjustment. Additionally, the other object of the invention is to provide a nut member that can improve the workability in assembling an aiming mechanism.

### Solution to Problem

The present invention is a nut member comprising: a fitting portion which is to be fitted in a fitting hole provided in a target member; and an internal thread portion which is to be screwed on to an external thread portion of a screw by an insertion of the screw, wherein the fitting portion and the internal thread portion are formed in different axial positions on the nut member. This screw is an aiming screw that is supported on a fixed member such as a lamp housing or the like of a lamp so as to turn on its own axis, and the nut member is an aiming nut supported on a tilting member such as a reflector or the like of the lamp.

Further, it is preferable that the fitting portion has a fitting groove that fits in the fitting hole, and a cavity is provided on an inner side of a groove bottom surface of the fitting groove. Furthermore, it is preferable that an introducing portion having an inverse cone surface is provided at an end portion of the internal thread portion from which the screw is inserted to guide a distal end of the screw.

### Advantageous Effects of Invention

According to the invention, the internal thread portion and the fitting portion are positioned to be offset from each other in the axial direction of the nut member, and therefore, there is caused no such situation that when the screw is screwed into the nut member, the internal thread portion is expanded radially outwards to increase excessively the operation force with which the screw is screwed. On the other hand, even though the internal thread portion is expanded radially outwards, there is caused no such situation that the expansion affects the fitting portion, and the fitting state of the fitting portion in the fitting hole can stably be held. When the nut member is applied to the aiming mechanism, this can improve the operability of the screw in turning it, and the target member such as the reflector can smoothly tilt as the nut member moves, as a result of which the operability in aiming adjustment can be improved.

### BRIEF DESCRIPTION OF THE DRAWINGS

FIG. 1 is an external perspective view of a form in which a nut member of the invention is configured as a self-locking nut.

FIG. 2 is an external perspective view of the nut member of FIG. 1 as seen from an opposite side.

FIG. 3 is a vertical cross sectional view of a form in which a vertical aiming portion of FIG. 6 is configured by the nut member of the invention.

FIG. 4 is a vertical cross sectional view in an axis direction of the nut member.

FIG. 5 is a plane view and a B-B cross sectional view of a fitting groove of the nut member.

FIG. 6 shows a schematic cross sectional view of a lamp having an aiming mechanism.

### DESCRIPTION OF EMBODIMENTS

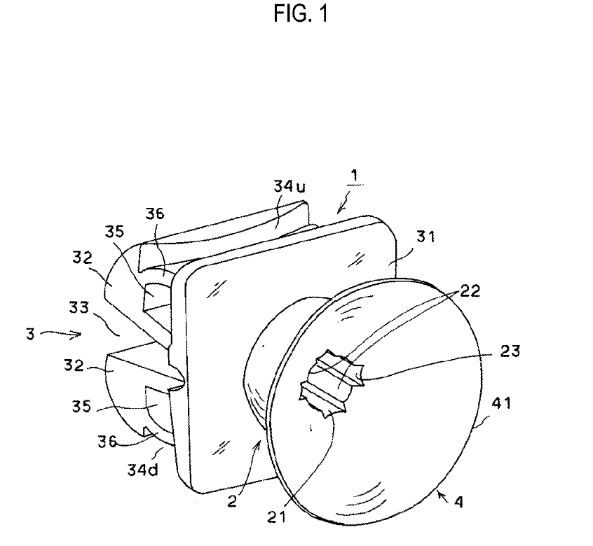

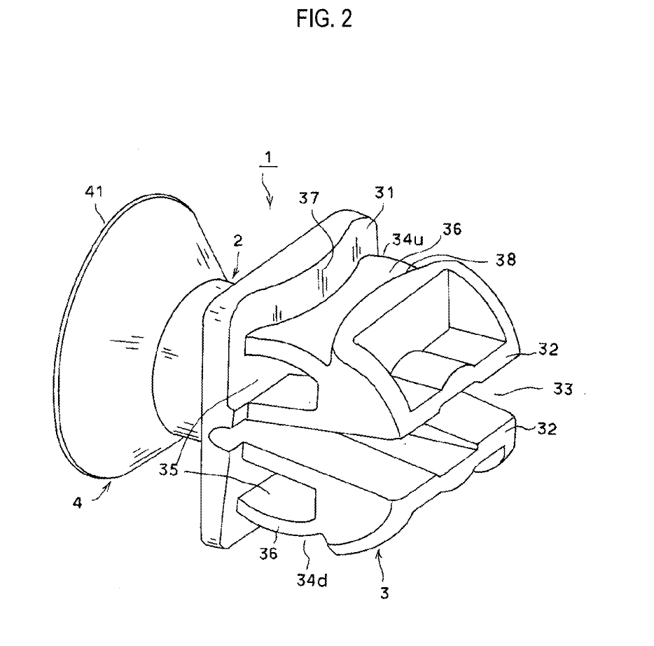

Next, an embodiment of the invention will be described by reference to the drawings. FIG. 1 is an external perspective view of a form in which the invention is configured as a self-locking nut, and FIG. 2 is an external perspective view of the self-locking nut (hereinafter, referred to as the nut member) 1 as seen from an opposite side.

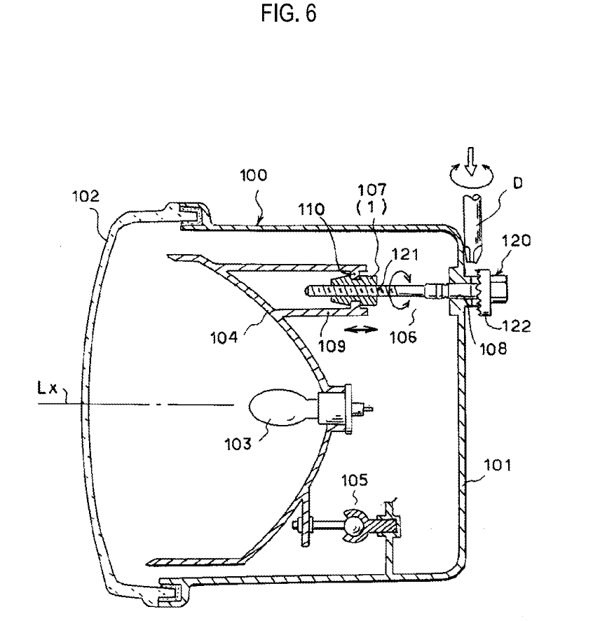

The nut member 1 corresponds to the aiming nut 107 shown in FIG. 6. This nut member 1 is fitted to be supported in a fitting hole 110 that is opened in a bracket 109 of a reflector 104 (a target member, an example of a tilting member) that is installed in a lamp housing 100. The nut member 1 is screwed on to an aiming screw 120 (hereinafter, referred to as a screw) that is supported in a lamp body 101 (an example of a fixed member) of the lamp housing 100 so as to turn on its own axis. When turning this screw 120 by operating a gear portion 122 that is exposed to the outside of the lamp housing, the nut member 1 moves in the axial direction of the screw 120. By moving so, the nut member 1 tilts the reflector 104 in a front-to-rear direction or a horizontal direction of the lamp on a fulcrum portion 105 as a fulcrum via the bracket 109, so that the aiming adjustment of an optical axis Lx of the lamp is executed.

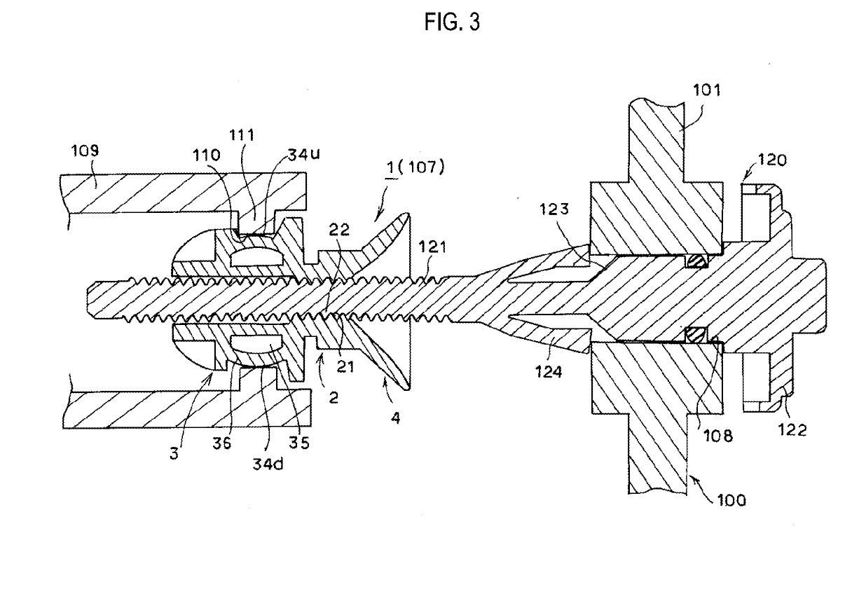

Although the detailed description of the screw 120 is omitted, FIG. 3 shows an axial vertical sectional view of a form in which the screw 120 and the nut member 1 configure a vertical aiming portion 106 shown in FIG. 6. As shown in FIG. 3, the screw 120 has a supported portion 123 that is inserted in a cylindrical supporting hole 108 provided in the lamp body 101. An external thread portion 121 is formed over a portion that lies further distal than the supported portion 123, and the gear portion 122 for turning operation is formed on a portion that is exposed to the outside of the lamp body 101 at a rear end side of the supported portion 123. Additionally, a pair of wing-shaped elastic locking pieces 124 are provided on the screw 120 at a front end portion of the supported portion 123 so as to be expanded radially towards the rear. When the screw 20 is inserted into the supporting hole 108 from the outside of the lamp body 101, rear end portions of the elastic locking pieces 124 are brought into elastic engagement with an inner edge of the supporting hole 108, whereby the supported portion 123 is locked in the supporting hole 108.

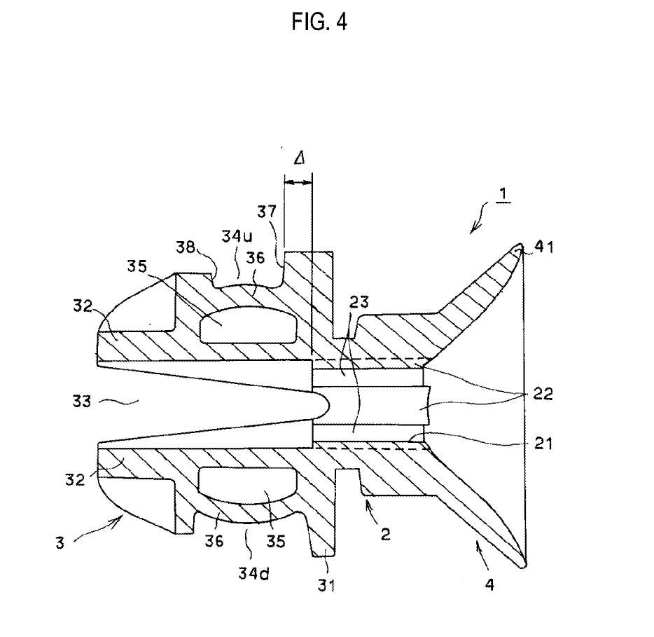

FIG. 4 is an axial vertical sectional view of the nut member 1. As shown in FIGS. 1 to 4, the nut member 1 includes an internal thread portion 2 that is formed as an internal thread in which an external thread portion 121 of the screw 120 is screwed and a fitting portion 3 at which the nut member 1 is fitted into the fitting hole 110 provided in the bracket 109 of the reflector 104 so as to be supported in the bracket 109. Additionally, in this embodiment, the nut member 1 includes an introducing portion 4 from which a distal end of the screw 120 is introduced into the internal thread portion 2 when the screw 120 is inserted into the nut member 1. The internal thread portion 2, the fitting portion 3 and the introducing portion 4 are formed integrally from a resin material. When referred to in the following description, the vertical direction and the horizontal direction are to be understood to denote such directions based on FIGS. 3 and 4.

The internal thread portion 2 is formed at an area in the axial direction of the nut member 1 and takes the shape of a short cylinder that has an axial hole 21 formed for insertion of the screw 120 thereinto from a front end side of the nut member 1. A plurality of or four elongated grooves 23 in this embodiment, are formed on an inner cylindrical circumferential surface 22 of the axial hole 21 so that the elongated grooves 23 are distributed circumferentially at equal intervals and extend in the axial direction. Thus, the inner circumferential surface 22 is configured as circumferentially divided inner circumferential surfaces. When the screw 120 is screwed to be press fitted into the axial hole 21 as will be described later, the surface of the inner circumferential surface 22 is cut spirally by the external thread portion 121 of the screw 120, whereby the internal thread portion 2 is formed as an internal thread. The elongated grooves 23 are provided so as not only to reduce the contact resistance of the screw 120 with the inner circumferential surface 22 when the screw 120 is inserted to facilitate the insertion of the screw 120 into the axial hole 21 but also to facilitate the turning of the screw 120 in forming the internal thread.

The introducing portion 4 is formed into a bell shape, that is, an inverse circular cone shape, that is, the introducing portion 4 projects from a right end of the internal thread portion 2 along the axial direction while it continuously becomes wider diametrically towards its projecting distal end side. A circular cone vertex angle of the introducing portion 4 that is formed into the inverse circular cone shape is set to as large an angle as possible within such an extent that the external dimension of the nut member 1 does not become too large. In this embodiment, the circular cone vertex angle of the introducing portion 4 is set to an angle in the range of 80 degrees to 90 degrees. Additionally, an outside diametric dimension of a circular distal edge 41 at the projecting distal end side of the introducing portion 4 is also set to as large a diametric dimension as possible within such an extent that an external dimension of the nut member 1 does not become too large, that is, to a diametric dimension that is larger than at least an external dimension of the fitting portion 3. In this embodiment, the outside diametric dimension of the distal edge 41 is set to a diametric dimension that is about four times an inside dimension of the internal thread portion 2, in other words, a diametric dimension that is about four times an outside diametric dimension of the external thread portion 121 of the screw 120. Further, at a base portion of an inner inverse conical surface having an inverse circular cone shape, of the introducing portion 4, that is, a portion of the introducing portion 4 that connects to the internal thread portion 2, the inverse conical surface is made to smoothly continue to the inner circumferential surface 22 of the internal thread portion 2. The conical surface that makes up the introducing portion 4 may be a pyramidal.

The fitting portion 3 is formed at the other axial end or left end portion of the internal thread portion 2. This fitting portion 3 includes a flange 31 that is provided in the other end position of the internal thread portion 2, and a pair of leg pieces 32 that extend in the axial direction from the flange 31 as a proximal end portion towards the other end so that they face each other vertically. As will be seen from a description to be made later, the flange 31 is formed as a rectangular plate, close to square in shape, which has an external dimension larger than an opening dimension of the fitting hole 110 so as to prevent the dislocation from the fitting hole 110 provided in the bracket 109. The axial hole 21 of the internal thread portion 2 passes through a central portion of the flange 31 so as to allow the passage of the screw 120 therethrough.

The pair of leg pieces 32 are disposed so as to face each other in the vertical direction by a wedge-shaped notch 33 that is formed in the axial direction from the other end of the nut member 1. These leg pieces 32 are connected to the flange 31 at proximal end portions that are oriented to the right, and the leg pieces 32 can be deformed elastically in the vertical direction from the proximal end portions as fulcrums. The leg pieces 32 are formed so as to have an external shape that is substantially the same as the shape of the fitting hole 110 that is opened in the bracket 109 when seen from the axial direction of the nut member 1, and to have the external shape that is slightly larger the opening dimension of the fitting hole 110 when seen from the vertical direction. in addition, due to a distal end of the notch 33 reaching the axial hole 21 of the internal thread portion 2, when the leg pieces 32 are elastically deformed inwards, the leg pieces 32 narrow part of the other end side of the inner circumferential surface 22 of the internal thread portion 2 to achieve a self-locking function.

Fitting grooves 34u, 34d (hereinafter, upper and lower fitting grooves may generally be denoted by reference numeral 34) are provided on areas at the side of the proximal end portions on upwardly and downwardly oriented outer circumferential surfaces of the leg pieces 32 in such a way as to be depressed inwards to a required depth. These fitting grooves 34u, 34d are formed at a portion that is offset in the direction of the other or left end with respect to the internal thread portion 2, in other words, at a portion that is offset in an opposite side to the introducing portion 4 in the axial direction with respect to the internal thread portion 2. Here, as shown in FIG. 4, the fitting grooves 34u, 34d are so offset by a dimension A. Of these upper and lower fitting grooves 34u, 34d, the upper fitting groove 34u is formed to a dimension, in the axial direction of the nut member 1, which is almost equal to a thickness of the bracket 109 that makes up an inner edge portion 111 of the fitting hole 110 of the bracket 109. On the other hand, the lower fitting groove 34d is formed to a dimension slightly larger than that of the upper fitting groove 34u and is formed over the full width of the nut member 1 in a direction that is at right angles the axial direction of the nut member 1. Additionally, a cavity 35 is formed in each leg piece 32 in an area inwards of a groove bottom surface of the fitting groove 34 in such a way as to penetrate in a width direction. An inner bottom portion of the fitting groove 34 is configured as a plate-like fitting plate portion 36 that is elastic in its thickness direction by the cavity 35. The volume of the resin in each leg piece 32 can be reduced by providing the cavity 35 in the way described above, whereby the generation of “sinking” in the fitting portion 3 when the nut member 1 is resin molded can be restricted, thereby making it possible to form the nut member that is highly accurate in dimensions.

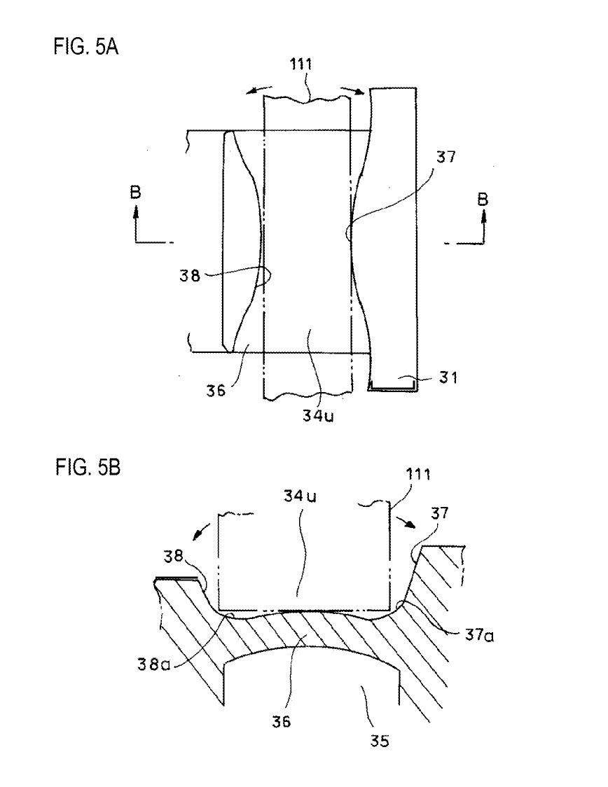

FIGS. 5(a), (b) are a plan view of the fitting groove 34u (34) of the nut member 1 and a sectional view thereof taken along a line B-B therein, respectively. As shown in FIG. 5(b), the fitting plate portion 36 has a sectional shape in which an axially central portion of the nut member 1 is curved so as to expand slightly radially outwards. This fitting plate portion 36 is formed as a part of a cylindrical surface that is formed by extending an arc surface that is centered at a part of the nut member 1 that lies on the axis thereof in the width direction. The fitting groove 34 is formed by the fitting plate portion 36 and a pair of rising wall portions 37, 38 that face each other in the axial direction. As shown in FIG. 5(a), this fitting groove 34 is narrowed in an axial direction at a widthwise central portion and is widened wider than the central portion at widthwise end portions. Thus, the fitting groove 34 is formed into an hourglass shape. The dimensions of the central portions differ between the upper and lower fitting grooves 34, and in the upper fitting groove 34u, the dimension of the central portion is almost equal to the thickness of the inner edge portion 111 of the fitting hole 110. Further, connecting surface portions 37a, 38a where the fitting plate portion 36 is connected to the rising wall portions 37, 38, respectively, are formed into a moderate curvilinear shape in axial direction. It is preferable that these connecting surface portions 37a, 38a are provided particularly on the upper fitting groove 34u.

In the nut member 1 configured in the way described above, in assembling the aiming mechanism shown in FIG. 6, when the pair of leg pieces 32 are inserted into the fitting hole 110 provided in the bracket 109 of the reflector 104, as shown in FIG. 3, the fitting grooves 34 of the leg pieces 32 are fitted in the inner edge portion 111 of the fitting hole 110. When the leg pieces 32 are inserted, the leg pieces 32 are elastically deformed inwards on the proximal end portions as fulcrums to thereby pass through the inner edge portion 111 of the fitting hole 110. The leg pieces 32 are restored elastically outwards after the passage through the inner edge portion 111, whereby the fitting grooves 34 are fitted in the inner edge portion 111, and the leg pieces 32 are held in the bracket 109 by means of their elastic restoring force. The fitting plate portions 36 of the fitting grooves 34 can be deformed radially by the cavities 35, and therefore, the fitting plate portions 36 are brought into abutment with the inner edge portion 111 of the fitting hole 110 with an elastic force resulting from their elastic deformations. Because of this, even though a slight dimension error is occurring between the fitting hole 110 and the fitting grooves 34, the leg pieces 32 can be kept fitted in the fitting hole 110 in an ensured fashion, whereby the nut member 1 can be held within the fitting hole 110 in a stable fashion.

Next, as shown in FIG. 6, with the reflector 104 provided in the lamp housing 100, the distal end of the screw 120 that is inserted from the rear of the lamp housing 100 is continuously inserted into the axial hole 21 in the internal thread portion 2 of the nut member 1. As this occurs, since the introducing portion 4 provided at the end of the nut member 1 is formed into the inverse circular cone shape, the distal end of the screw 120 is brought into abutment with an inner surface of the introducing portion 4 as the screw 120 is continuously inserted and continues to advance while being guided by the inverse circular cone shape of the inner surface. As a result, the distal end of the screw 120 is guided towards a center position of the nut member 1 and introduced to the axial hole 21 in the internal thread portion 2. Consequently, even though a slight position error is occurring in providing the reflector 104 within the lamp housing 100, in case the magnitude of the position error falls within a diametric dimension of the distal edge 41 of the introducing portion 4, the distal end of the screw 120 can be introduced into the axial hole 21 in the internal thread portion 2 in an ensured fashion so that the screw 120 can be inserted into the internal thread portion 2. Then, when the screw 120 is turned by turning the gear portion 122 of the screw 120, the external thread portion 121 of the screw 120 advances to enter the internal thread portion 2 of the nut member 1. As this occurs, the external thread portion 121 advances, while it is forming an internal thread on the inner circumferential surface 22 of the internal thread portion 2. This causes the external thread portion 121 of the screw 120 to be screwed in the internal thread portion 2 of the nut member 1, this completing the assembling of the aiming portion.

Here, when the external thread portion 121 of the screw 120 is screwed into the internal thread portion 2 of the nut member 1, the external thread portion 121 is inserted in the internal thread portion 2 in a press-fit fashion. Because of this, the internal thread portion 2 of the nut member 1 is formed in such a way as to expand radially outwards, this increasing slightly the outside diametric dimension of the internal thread portion 2. As this occurs, since the internal thread portion 2 is positioned to be offset from the fitting portion 3 or more particularly from the fitting grooves 34 in the axial direction, even though the outside diametric dimension of the internal thread portion 2 is increased, there is caused no such situation that the force that brings the fitting plate portions 36 into abutment with the inner edge portion 111 of the fitting hole 110 is increased. In other words, the internal thread portion 2 can expand freely radially outwards when the screw 120 is inserted thereinto, and hence, there is caused no such situation that the operation force that is exerted on the screw 120 when the screw 120 is inserted becomes too large.

Additionally, due to the internal thread portion 2 and the fitting grooves 34 being offset from each other in the axial direction, even though the outside diametric dimension of the internal thread portion 2 is increased as a result of the screw 120 being inserted into the nut member 1, the abutment force is not increased which brings the fitting plate portions 36 into abutment with the inner edge portion 111 of the fitting hole 110. Because of this, the degree of freedom in relative movement between the fitting hole 110 and the fitting grooves 34 is ensured when the fitting grooves 34 fit in the fitting groove 110. On the other hand, the pair of leg pieces 32 are elastically pressed inwards as a result of the fitting grooves 34 fitting in the fitting hole 110, and therefore, the diametric dimension of the axial hole in the internal thread portion 2 is reduced at the proximal end portions of the leg pieces 32. This presses on the internal thread portion 2 radially inwards relative to the external thread portion 121 of the screw 120, whereby the self locking function is achieved.

The position where the internal thread portion 2 of the nut member 1 is screwed on to the external thread portion 121 is changed by turning the screw 120, and in association with this, the nut member 1 is moved in the axial direction relative to the screw 120. As a result of the nut member 1 being moved in that way, the bracket 109, that is, the reflector 104 is allowed to tilt on the fulcrum portion 105 as the fulcrum. As this occurs, the nut member 1 is moved in a straight line in the direction that follows the axial direction of the screw 120, and the reflector 104 is moved in an arcing direction that is centered at the fulcrum portion 105. Therefore, a minute relative movement needs to be allowed between the nut member 1 and the reflector 104. Here, the fitting plate portions 36 of the fitting grooves 34 of the nut member 1 are fitted in the inner edge portion 111 of the fitting hole 110 by means of the elastic force due to the cavities 35. Because of this, the nut member 1 is moved relatively in the thickness direction of the fitting plate portions 36 within the fitting hole 110, permitting the relative movement in the thickness direction, that is, in the vertical direction. Additionally, the fitting plate portions 36 that are in abutment with the inner edge portion 111 of the fitting hole 110 are formed into a cylindrical surface. Because of this, the nut member 1 is moved relatively in the arcing direction of the cylindrical surface within the fitting hole 110, and relative tilting in the vertical direction, that is, in the tilting direction of the reflector 104 is also permitted.

Further, the fitting groove 34 has the hourglass shape when it is seen from the plane view, and therefore, the nut member 1 can tilt relatively to the inner edge portion 111 of the fitting hole 110 in the plane direction of the fitting groove 34, and hence, tilting in the plane direction, that is, in left and right directions indicated by arrows in FIG. 5(a) is permitted. On the other hand, the fitting groove 34 has the hourglass shape in which the center thereof in the width direction is narrowed, and therefore, even when the nut member 1 tilts relative to the fitting hole 110 in the horizontal direction, the inner edge portion 111 of the fitting hole 110 tilts relatively on the center of the fitting groove 34 in the width direction as the fulcrum. Because of this, the relative position between the nut member 1 and the fitting hole 110 in the axial direction of the screw 120 is maintained constant. Additionally, even though the abutment position between the inner edge portion 111 of the fitting hole 110 and fitting plate portion 36 changes, the inner edge portion 111 of the fitting hole 110 is brought into sliding abutment with the fitting plate portion 36 by the moderately curvilinear connecting surface portions 37a, 38a that are provided at both the end portions of the fitting plate portion 36, as shown in FIG. 5(b). Because of this, the smooth relative tilting can be ensured between both the members, that is, the relative tilting in the vertical direction of the nut member 1 can be ensured, as indicated by arrows in FIG. 5(b). Although not depicted in the figure, the lower fitting groove 34d has the larger width dimension than that of the inner edge portion 111, and therefore, the inner edge portion 111 can move within the fitting groove 34d, this enabling the relative movement described above.

In this way, the nut member 1 can tilt in the left and right directions and the vertical direction relative to the reflector 104, and the insertion of the screw 120 can be realized with as small an operation force as possible while allowing the reflector 104 to tilt smoothly also by the straight-line movement of the nut member 1. This can improve the workability in assembling the aiming mechanism.

By enabling the insertion of the screw 120 in the way described above, also in turning the screw 120 to adjust the aiming of the lamp, the smooth screwing of the nut member 1 and the smooth tilting of the reflector 104 can be enabled, as a result of which the smooth aiming adjustment with only the small operation force can be realized. Namely, although the description will partly be repeated, in FIG. 6, the nut member 1 screwed on to the external thread portion 121 is moved in the axial direction of the screw 120 by turning the screw 120 by turning the gear portion 122 of the screw 120 with a tool D such as a screw driver. The bracket 109 of the reflector 104 that fits on the nut member 1 is moved in the axial direction of the screw 120 by the movement of the nut member 1 described above, whereby the reflector 104 is allowed to tilt about the fulcrum portion 105. This tilts the optical axis Lx of the lamp, realizing the aiming adjustment. When the reflector 104 tilts in the way described above, the configurations of the fitting grooves 34 of the nut member 1 permit the relative movement between the nut member 1 that moves in a straight line and the reflector 104 that tilts. This restricts the generation of a load between the nut member 1 and the reflector 104 and the smooth turning of the screw 120 and the smooth tilting of the reflector 104 are enabled, thereby making it possible to realize the highly controllable aiming adjustment.

In addition, the cavities 35 are provided on the inner sides of the fitting grooves 34 that make up the fitting portion 3. Therefore, the fitting portion 3 is brought into elastic abutment with the fitting hole 110 in the bracket 109. Because of this, even in the event that a dimension error is occurring between the fitting hole 110 and the fitting portion 3, not only can the preferred fitting state be ensured, but also the tilting of the reflector 104 associated with the movement of the nut member 1 can be made smooth.

Further, the introducing portion 4 having the inverse conical surface that guides the distal end of the screw 120 is provided at the end portion of the internal thread portion 2 from which the screw 120 is inserted. This facilitates the inserting work of the screw 120 into the nut member 1.

In the embodiment, the reflector is described as being caused to tilt in the vertical direction for aiming adjustment. However, the invention can also be applied to a case where the reflector is caused to tilt in the horizontal direction for aiming adjustment or a case where the reflector is caused to tilt in different directions from those described above. In any case, in fitting the nut member in the reflector to be supported therein, the nut member should be fitted in the reflector with the lower side of the nut member, that is, the side of the nut member where the fitting groove that is wider in width is formed oriented towards the side of the reflector where the tilting fulcrum is present. Additionally, in the embodiment, the pair of leg pieces are described as being provided on the fitting portion. However, the number of leg pieces is not limited thereto, provided that the leg pieces are elastically deformed in the radial direction to be fitted in the fitting hole. In particular, the shape and number of leg pieces can be set as required according to the shape of the fitting hole. Additionally, as to the fitting grooves, the configuration thereof can be adapted to the shape of the fitting hole.

In this embodiment, while the nut member of the invention is applied to the self-locking nut, the invention is preferably applied to a nut member in which an internal thread portion is formed in advance, provided that the nut member is formed by resin molding and the like and the internal thread portion formed integrally expands radially outwards as a result of a screw being inserted thereinto.

While the invention has been described in detail by reference to the specific embodiment, it is obvious to those skilled in the art to which the invention pertains that various alterations and modifications can be made without departing from the spirit and scope of the invention.

This patent application is based on the Japanese Patent Application (No. 2012-170698) filed on Aug. 1, 2012, the contents of which are incorporated herein by reference.

### INDUSTRIAL APPLICABILITY

The invention can be adopted for a nut member such as a self-locking nut or the like that is used in a vehicle lamp including an aiming mechanism.

1. A nut member comprising:
a fitting portion which is to be fitted in a fitting hole provided in a target member; and
an internal thread portion which is to be screwed on to an external thread portion of a screw by an insertion of the screw,
wherein the fitting portion and the internal thread portion are formed in different axial positions on the nut member.

2. The nut member according to claim 1, wherein the fitting portion has a fitting groove that fits in the fitting hole, and a cavity is provided on an inner side of a groove bottom surface of the fitting groove.

3. The nut member according to claim 1, wherein an introducing portion having an inverse cone surface is provided at an end portion of the internal thread portion from which the screw is inserted to guide a distal end of the screw.

4. The nut member according to claim 1, wherein the screw is an aiming screw that is supported on a fixed member of a lamp so as to turn on its own axis, and the nut member is an aiming nut that is supported on a tilting member such as a reflector or the like of the lamp.
